(19) United States
(12) Patent Application Publication
(10) Pub. No.: US 2023/0205637 A1
(43) Pub. Date: Jun. 29, 2023

(54) Backup Recovery System and Method for Modern Application

(71) Applicant: Aishu Technology Corp., Minhang District, Shanghai (CN)

(72) Inventors: Feng Zhou, Minhang District, Shanghai (CN); Hongfu He, Minhang District, Shanghai (CN); Sha Tong, Minhang District, Shanghai (CN)

(21) Appl. No.: 17/996,077

(22) PCT Filed: Oct. 28, 2020
(86) PCT No.: PCT/CN2020/124228

§ 371 Date: Oct. 12, 2022

(30) Foreign Application Priority Data
Apr. 14, 2020 (CN) 202010290227.X

(51) Int. Cl. G06F 11/14

(52) U.S. Cl. CPC G06F 11/1448; G06F 11/1469; G06F 2201/80

(57) ABSTRACT

A backup recovery system for a modern application includes a modern application module and a backup module. The modern application module includes a service unit, an object storage gateway, a database, and an object storage. The service unit is configured to generate a large object, small objects, and service metadata, send the large object and the small objects to an object storage gateway, and store the service metadata in a database. The object storage gateway is configured to store the large object and the small objects in the object storage, merge the small objects into a large object, store the merged large object in the object storage, generate object metadata, and store the object metadata in the database. The backup module includes a metadata backup unit configured to back up the database and an object storage backup unit configured to back up large objects.

This application claims priority to Chinese Patent Application No. 202010290227.X filed with the China National Intellectual Property Administration (CNIPA) on Apr. 14, 2020, the disclosure of which is incorporated herein by reference in its entirety.

### TECHNICAL FIELD

The present application relates to data storage technology, for example, a backup recovery system and method for a modern application.

### BACKGROUND

With the rapid development of the Internet and the implementation of cloud technology, there are more and more mobile working and cross-region collaboration. Under this background, a variety of modern application systems based on object storage emerge and develop rapidly, and a large amount of data floods into the modern application systems. A modern application system includes a service unit, a database, and object storage. The features of the modern application system are that data is stored in the object storage, service metadata is stored in the database, and the object storage provides only a basic object read-write function. It is a problem to quickly back up and recover the entire modern application system.

The related art also provides some solutions. Chinese Patent CN201610565116.9 proposes a data backup method and system for object storage. The method includes the following: A snapshot and snapshot information are created for a storage object in a storage bucket of object storage, and according to the update request of a user for the storage object, and the historical snapshot corresponding to the storage object and the backup feature information of the storage object in the snapshot information are queried; a backup check code related to the backup feature information is sent to the user for verification; according to the verification result fed back by the user, the to-be-received update data information of the storage object is determined; and after the determined update data information is received, the update of the storage object in the object storage is completed. In this manner, the data security of the user is guaranteed to the greatest extent, and the storage capacity of the data disaster backup performed by the user is reduced. Moreover, the waste of a public network bandwidth caused by the backup of all data performed by the user is avoided, and the cost is saved.

However, the preceding solution has the problems below.

The backup recovery of the object storage can only use a storage object as a read-write unit. The data sizes of a storage object are different. The data stored in the object storage may be some small files. With the increase in the number of storage objects, the time required for a backup is longer and longer. Once a modern application system fails, it takes a long time to recover. As a result, a long service interruption is caused, and the requirements for the backup recovery cannot be satisfied.

### SUMMARY

The present application provides a backup recovery system and method for a modern application, which has high efficiency and good security.

The present application may be implemented by the technical solutions hereinafter.

A backup recovery system for a modern application includes a modern application module and a backup module.

The modern application module includes a service unit, an object storage gateway, a database, and an object storage. The service unit is connected to the object storage gateway and the database. The service unit is configured to generate a large object, small objects, and service metadata, send the large object and the small objects to the object storage gateway, and store the service metadata in the database.

The object storage gateway is connected to the database and the object storage. The object storage gateway is configured to receive the large object and the small objects, store the large object and the small objects in the object storage, merge the small objects into a large object, store the merged large object in the object storage, generate object metadata, and store the object metadata in the database.

The database is configured to store the service metadata and the object metadata.

The backup module includes a metadata backup unit and an object storage backup unit. The metadata backup unit is connected to the database and configured to perform a periodic backup on the database to generate metadata backup sets at different time points. The object storage backup unit is connected to the object storage and configured to back up large objects in the object storage to generate large object copies.

The metadata backup unit and the object storage backup unit are also configured to use the metadata backup sets and the large object copies to implement damage recovery and historical recovery of the modern application module.

The metadata backup unit and the object storage backup unit are configured to use the metadata backup sets and the large object copies to implement the damage recovery of the modern application module in the manners below.

The object storage backup unit restores the large object copies to the object storage. The metadata backup unit restores the metadata backup set at the latest time point to the database.

The metadata backup unit and the object storage backup unit are configured to use the metadata backup sets and the large object copies to implement the historical recovery of the modern application module in the manners below.

The metadata backup unit restores the metadata backup set at a specified time point to the database. The object storage backup unit queries the database for a large object corresponding to the specified time point and restores the large object to the object storage.

The service unit is also configured to send an object write request and an object read request to the object storage gateway.

In the case where the object storage gateway receives the object write request, the object storage gateway is configured to receive the large object and the small objects generated by the service unit and directly store the large object in the object storage. In the case where the data volume of the small objects reaches a set threshold, the object storage gateway is configured to merge all the small objects into the large object, store the merged large object in the object storage, generate the object metadata, store the object metadata in the database, and delete all the small objects.

The object storage gateway is configured to, in response to receiving the object read request, determine whether the object metadata exists in the database. In response to the determination result that the object metadata exists in the database, the object storage gateway is configured to read the data of a specified position and a specified length in the large object corresponding to the object metadata in the object storage according to the object metadata. In response to the determination result that the object metadata does not exist in the database, the object storage gateway is configured to directly read the large object in the object storage.

The object storage gateway adopts an object storage S3 interface.

A backup recovery method for a modern application includes the steps below.

The service unit generates the large object, the small objects, and the service metadata, sends the large object and the small objects to the object storage gateway, and stores the service metadata in the database. The object storage gateway receives the large object and the small objects, stores the large object and the small objects in the object storage, merges the small objects into the large object, stores the merged large object in the object storage, generates the object metadata, and stores the object metadata in the database.

The metadata backup unit performs the periodic backup on the database to generate the metadata backup sets at different time points. The object storage backup unit performs a periodic backup on the large objects in the object storage to generate the large object copies.

The metadata backup unit and the object storage backup unit use the metadata backup sets and the large object copies to implement damage recovery and historical recovery of the database and the object storage.

The metadata backup unit and the object storage backup unit use the metadata backup sets and the large object copies to implement the damage recovery of the database and the object storage in the manners below.

The object storage backup unit restores the large object copies to the object storage. The metadata backup unit restores the metadata backup set at the latest time point to the database.

The metadata backup unit and the object storage backup unit use the metadata backup sets and the large object copies to implement the historical recovery of the database and the object storage in the manners below.

The metadata backup unit restores the metadata backup set at a specified time point to the database. The object storage backup unit queries the database for a large object corresponding to the specified time point and restores the large object to the object storage.

The method also includes sending the object write request and the object read request to the object storage gateway by the service unit.

The object storage gateway receives the large object and the small objects, stores the large object and the small objects in the object storage, merges the small objects into the large object, generates the object metadata of the large object, and stores the object metadata in the database in the following: In the case where the object storage gateway receives the object write request, the object storage gateway receives the large object and the small objects generated by the service unit and directly stores the large object in the object storage; and in the case where the data volume of the small objects reaches the set threshold, the object storage gateway merges all the small objects into the large object, stores the merged large object in the object storage, generates the object metadata, stores the object metadata in the database, and deletes all the small objects.

The method also includes the following: In response to receiving the object read request, the object storage gateway determines whether the object metadata exists in the database. In response to the determination result that the object metadata exists in the database, the object storage gateway reads the data of a specified position and length in the corresponding large object in the object storage according to the object metadata. In response to the determination result that the object metadata does not exist in the database, the object storage gateway directly reads the large objects.

The object storage gateway adopts the object storage S3 interface.

### BRIEF DESCRIPTION OF DRAWINGS

FIG. 1 is a diagram illustrating the structure of a backup recovery system for a modern application according to an embodiment of the present application.

### DETAILED DESCRIPTION

The present application is described below in conjunction with drawings and embodiments. The embodiments are implemented on the basis of the solution of the present application. Embodiments and operation processes are given, but the scope of the present application is not limited to the embodiments hereinafter.

In the related art, the backup recovery of object storage can only use a storage object as a read-write unit. The data sizes of a storage object are various. The data stored in the object storage may be some small files. With the increase in the number of storage objects, the time required for a backup is longer and longer. Once a modern application system fails, it takes a long time to recover and causes a long service interruption, so that the requirements for the backup recovery cannot be satisfied. At the same time, a database is not backed up in the related art, and a service unit cannot provide a service without service metadata, so that the integrity of the backup of a modern application cannot be satisfied.

### EMBODIMENT ONE

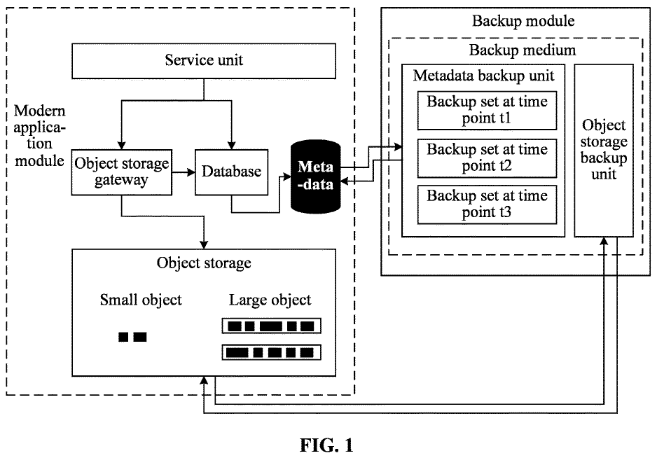

This embodiment provides a backup recovery system for a modern application. As shown in FIG. 1, the backup recovery system provided by this embodiment includes a modern application module and a backup module.

The modern application module includes a service unit, an object storage gateway, a database, and object storage. The service unit is configured to generate a large object, small objects, and service metadata. The object storage gateway is configured to receive and send the large object and the small objects, store and query for the large object and the small objects in the object storage, merge the small objects into a large object, and generate object metadata. The object storage gateway adopts the interface of the object storage S3 standard protocol to implement the common interface of the object storage. The database is configured to store metadata. The metadata includes the service metadata and the object metadata. The service metadata is data required by the service unit to process a service. The service metadata includes user information, user permission, information of a user file stored in the bucket of the object storage, and an object name. The object metadata includes the name, offset, and length of the large object corresponding to the merged small objects. The offset is the starting position of a small object in the large object. The length is the length of the small objects.

The backup module includes a metadata backup unit and an object storage backup unit. The metadata backup unit is configured to back up the metadata in the database to generate metadata backup sets at different time points. The object storage backup unit is configured to back up large objects in the object storage to generate large object copies.

The metadata backup unit and the object storage backup unit use the metadata backup sets and the large object copies to implement damage recovery and historical recovery of the modern application module.

The damage recovery process is the following: The object storage backup unit restores the large object copies to the object storage, and the metadata backup unit restores the metadata backup set at the latest time point to the database.

The historical recovery process is the following: The metadata backup unit restores the metadata backup set at a specified time point to the database, and the object storage backup unit queries the database for the data of a specified position and a specified length in a large object corresponding to a specified time point and restores the large object to the object storage. In this manner, the data at a historical time point can be recovered.

The address for accessing the object storage by the service unit is changed to the address of the object storage gateway, so that all operations of accessing the object storage by the service unit are taken over by the object storage gateway. The service unit sends an object write request and an object read request to the object storage gateway. When the object storage gateway receives the object write request, the object storage gateway receives the large object and the small objects generated by the service unit and directly stores the large object in the object storage. When the data volume of the small objects reaches a set threshold, the object storage gateway merges all the small objects into a large object, generates the object metadata, stores the object metadata in the database, and then deletes the corresponding small objects. When the object storage gateway receives the object read request, the object storage gateway first determines whether the object metadata exists in the database. If the object metadata exists in the database, the object storage gateway reads the data of a specified position and length in the corresponding large object in the object storage according to the object metadata. If the object metadata does not exist in the database, the object storage gateway directly reads the large objects.

Many users exist in a document cloud. The users have a large number of files such as pictures and documents. These files are directly stored in the object storage. Although the reliability of the data in the object storage is very high, to further ensure security, data protection is also required. The implementation steps are below.

The address of accessing the object storage is modified to the address of the object storage gateway. The large objects stored in the object storage and the metadata in the database are backed up by the object storage backup unit and the metadata backup unit respectively. When recovery is required, the metadata backup set and the large object copy at a specified time point are selected for recovery.

In this embodiment, a large object and a small object correspond to a large file and a small file of the service unit, respectively.

The large file may be a file having a data volume greater than a threshold. The small file may be a file having a data volume less than or equal to the threshold.

### EMBODIMENT TWO

A backup recovery method for a modern application corresponding to embodiment one includes the following: The service unit generates the large object, the small objects, and the service metadata; the object storage gateway receives the large object and the small objects, stores the large object and the small objects in the object storage, merges the small objects into the large object, generates the object metadata, and stores the object metadata in the database, where the object storage gateway adopts the object storage S3 interface; the metadata backup unit performs the periodic backup on the database to acquire the metadata backup sets at different time points; the object storage backup unit performs the periodic backup on the large objects in the object storage to generate the large object copies; and the metadata backup sets and the large object copies are used to implement the damage recovery and the historical recovery of the database and the object storage. The service metadata is the data required by the service unit to process a service. The service metadata includes user information, user permission, information of a user file stored in the bucket of the object storage, and an object name. The object metadata includes the name, offset, and length of the large object corresponding to the merged small objects.

The damage recovery process is the following: The object storage backup unit restores the large object copies to the object storage, and the metadata backup unit restores the metadata backup set at the latest time point to the database.

The historical recovery process is the following: The metadata backup unit restores the metadata backup set at a specified time point to the database, and the object storage backup unit queries the database for the data of a specified position and length in the large object corresponding to a specified time point and restores the large object to the object storage. In this manner, the data at a historical time point may be recovered.

Object storage information is configured in the object storage gateway. The address of accessing the object storage by the service unit is changed to the address of the object storage gateway, so that all operations of accessing the object storage by the service unit are taken over by the object storage gateway. The service unit sends the object write request and the object read request to the object storage gateway. When the object storage gateway receives the object write request, the object storage gateway receives the large object and the small objects generated by the service unit and directly stores the large object in the object storage. When the data volume of the small objects reaches the set threshold, the object storage gateway merges all the small objects into a large object, generates the object metadata, stores the object metadata in the database, and then deletes the corresponding small objects. When the object storage gateway receives the object read request, the object storage gateway first determines whether the object metadata exists in the database. If the object metadata exists in the database, the object storage gateway reads the data of a specified position and length in the corresponding large object in the object storage according to the object metadata. If the object metadata does not exist in the database, the object storage gateway directly reads the large objects.

Embodiment one and embodiment two provide a backup recovery system and method for a modern application. The system and method belong to the fields of a computer software modern application system and a data backup and relate to technology such as a service system and backup recovery based on object storage. Backup recovery technology is used to perform rapid backup recovery on a modern application system. In this manner, the problem of backup recovery performance of the modern application system is solved, and the data of the modern application is quickly backed up to a backup medium. When the modern application system is damaged, the data in the backup medium can be quickly restored to the modern application system to implement rapid backup recovery of the modern application system.

In the present application, the object storage gateway receives and sends the large object and the small objects and merges the small objects. The metadata backup unit performs a periodic backup on the metadata in the database to generate the metadata backup sets at different time points. The object storage backup unit is configured to back up the large objects in the object storage to generate the large object copies. In this manner, the backup efficiency is high. alternatively, when the modern application module is damaged, or the historical recovery is performed, a data backup can be completed fully and quickly through the metadata backup sets and the large object copies. In this manner, the efficiency is high, the operation is convenient, and the security is good.

In the present application, the object storage gateway automatically merges the small objects reaching a certain data volume into the large object. The metadata backup set at a specified time point is restored to the database, and the object storage backup unit queries the database for the corresponding large object and restores the large object to the object storage. In this manner, historical data can be recovered. The metadata backup set at the latest time point is restored to the database, and all the large object copies are restored to the object storage. In this manner, the recovery after the modern application module is damaged can be completed. The metadata backup sets and the large object copies are always incremental backups. Thus, the historical data can be completely stored. Moreover, the security is good, and the traceability is strong. Alternatively, a large object is used as a unit for transmission, and thus the efficiency is high.

1. A backup recovery system for a modern application, comprising:
a modern application module comprising a service unit, an object storage gateway, a database, and an object storage, wherein
the service unit is connected to the object storage gateway and the database, and the service unit is configured to generate a large object, small objects, and service metadata, send the large object and the small objects to the object storage gateway, and store the service metadata in the database;
the object storage gateway is connected to the database and the object storage, the object storage gateway is configured to receive the large object and the small objects, store the large object and the small objects in the object storage, merge the small objects into a large object, store the merged large object in the object storage, generate object metadata, and store the object metadata in the database; and
the database is configured to store the service metadata and the object metadata; and
a backup module comprising a metadata backup unit and an object storage backup unit, wherein the metadata backup unit is connected to the database and configured to back up the database to generate metadata backup sets at different time points, and the object storage backup unit is connected to the object storage and configured to back up large objects in the object storage to generate large object copies; and
the metadata backup unit and the object storage backup unit are further configured to use the metadata backup sets and the large object copies to implement damage recovery and historical recovery of the modern application module.

2. The system according to claim 1, wherein the metadata backup unit and the object storage backup unit are configured to use the metadata backup sets and the large object copies to implement the damage recovery of the modern application module in the following manners:
the object storage backup unit restores the large object copies to the object storage, and the metadata backup unit restores a metadata backup set at a latest time point to the database.

3. The system according to claim 1, wherein the metadata backup unit and the object storage backup unit are configured to use the metadata backup sets and the large object copies to implement the historical recovery of the modern application module in the following manners:
the metadata backup unit restores a metadata backup set at a specified time point to the database, and the object storage backup unit queries the database for a large object corresponding to the specified time point and restores the large object to the object storage.

4. The system according to claim 1, wherein
the service unit is further configured to send an object write request and an object read request to the object storage gateway;
the object storage gateway is configured to, in response to receiving the object write request, receive the large objects and the small objects generated by the service unit and store the large objects in the object storage, and, in a case where a data volume of the small objects reaches a set threshold, merge all the small objects into a large object, store the merged large object in the object storage, generate the object metadata, store the object metadata in the database, and delete all the small objects; and
the object storage gateway is configured to, in response to receiving the object read request, determine whether the object metadata exists in the database; and the object storage gateway is further configured to, in response to a determination result that the object metadata exists in the database, read data of a specified position and a specified length in the large object corresponding to the object metadata in the object storage according to the object metadata, or, in response to a determination result that the object metadata does not exist in the database, read the large object in the object storage.

5. The system according to claim 1, wherein the object storage gateway adopts an object storage S3 interface.

6. A backup recovery method for a modern application, comprising:
generating, by a service unit, a large object, small objects, and service metadata, sending the large object and the small objects to an object storage gateway, and storing the service metadata in a database; and receiving, by the object storage gateway, the large object and the small objects, storing the large object and the small objects in an object storage, merging the small objects into a large object, storing the merged large object in the object storage, generating object metadata, and storing the object metadata in the database;
performing, by a metadata backup unit, a periodic backup on the database to generate metadata backup sets at different time points and performing a periodic backup on large objects in the object storage by an object storage backup unit to generate large object copies; and
using, by the metadata backup unit and the object storage backup unit, the metadata backup sets and the large object copies to implement damage recovery and historical recovery of the database and the object storage.

7. The method according to claim 6, wherein using, by the metadata backup unit and the object storage backup unit, the metadata backup sets and the large object copies to implement the damage recovery of the database and the object storage comprises:
restoring, by the object storage backup unit, the large object copies to the object storage and restoring, by the metadata backup unit, a metadata backup set at a latest time point to the database.

8. The method according to claim 6, wherein using, by the metadata backup unit and the object storage backup unit, the metadata backup sets and the large object copies to implement the historical recovery of the database and the object storage comprises:
restoring, by the metadata backup unit, a metadata backup set at a specified time point to the database, and querying, by the object storage backup unit, the database for a large object corresponding to the specified time point and restoring the large object to the object storage.

9. The method according to claim 6, further comprising sending, by the service unit, an object write request and an object read request to the object storage gateway,
wherein receiving, by the object storage gateway, the large object and the small objects, storing the large object and the small objects in the object storage, merging the small objects into the large object, generating the object metadata, and storing the object metadata in the database comprise: in a case where the object storage gateway receives the object write request, receiving, by the object storage gateway, the large object and the small objects generated by the service unit and storing the large object in the object storage; and in a case where a data volume of the small objects reaches a set threshold, merging, by the object storage gateway, all the small objects into the large object, storing the merged large object in the object storage, generating the object metadata, storing the object metadata in the database, and deleting all the small objects; and
wherein the method further comprises: in response to receiving the object read request, determining, by the object storage gateway, whether the object metadata exists in the database; and in response to a determination result that the object metadata exists in the database, reading, by the object storage gateway, data of a specified position and a specified length in the corresponding large object in the object storage according to the object metadata, or in response to a determination result that the object metadata does not exist in the database, reading, by the object storage gateway, the large object.

10. The method according to claim 6, wherein the object storage gateway adopts an object storage S3 interface.
